(19) United States
(12) Patent Application Publication
(10) Pub. No.: US 2025/0222619 A1
(43) Pub. Date: Jul. 10, 2025

(54) CHAINSAWS AND CLUTCHES FOR CHAINSAWS

(71) Applicant: Milwaukee Electric Tool Corporation, Brookfield, WI (US)

(72) Inventors: Kevin Puls, Brookfield, WI (US); Beth E. Cholst, Brookfield, WI (US); Hans Banholzer, Brookfield, WI (US); Jacob Seifert, Brookfield, WI (US); Adam Ostrowski, Milwaukee, WI (US); David B. Marolla, Menomonee Falls, WI (US)

(21) Appl. No.: 18/987,487

(22) Filed: Dec. 19, 2024

Related U.S. Application Data
(60) Provisional application No. 63/618,008, filed on Jan. 5, 2024.

(51) Int. Cl. B27B 17/10; B27B 17/02; F16D 43/18

(52) U.S. Cl. CPC B27B 17/10; B27B 17/02; F16D 43/18

(57) ABSTRACT

A chainsaw includes a sprocket coupled to a chain and configured to drive the chain, wherein the sprocket comprises a receiving area defining a drive surface; a clutch disposed at least partially in the receiving area of the sprocket, wherein the clutch comprises: a hub defining a central axis, the hub being rotationally keyed to an output shaft of a motor; a centrifugal weight disposed between the hub and the sprocket and movable in a radial direction relative to the central axis; and a spring compressed between the hub and the centrifugal weight to bias the centrifugal weight in a radial direction towards the central axis; wherein the centrifugal weight comprises a drive feature on a radially outer surface, and wherein the drive feature is configured to selectively interface with the drive surface of the sprocket when the output shaft is rotating above a threshold rotational speed.

### CROSS-REFERENCE TO RELATED APPLICATIONS

The present application claims priority to U.S. provisional patent application Ser. No. 63/618,008 filed on Jan. 5, 2024, the disclosure of which is incorporated by reference herein in its entirety

### FIELD

The present disclosure relates generally to clutches and more particularly to electric chainsaws with clutches.

### BACKGROUND

Typically, prime movers such as motors, are connected to output shafts of machines through one or more meshing interfaces which selectively transmit power from the prime mover to the output shaft. These meshing interfaces allow the prime mover to selectively drive an output element of the machine.

### BRIEF DESCRIPTION

In accordance with the present disclosure various aspects and embodiments will be set forth in part in the following description.

In accordance with one embodiment, an electric chainsaw is provided. The electric chainsaw includes a housing; a bar extending from the housing and defining a track; a chain movable relative to the track; an electric power source; a motor configured to receive power from the electric power source; a sprocket operably coupled to the chain and configured to drive the chain on the track, wherein the sprocket comprises a receiving area defining a drive surface on a radially inner surface of the receiving area; a clutch disposed at least partially in the receiving area of the sprocket, wherein the clutch comprises: a hub defining a central axis, the hub being rotationally keyed to an output shaft of the motor; a centrifugal weight disposed between the hub and the sprocket and movable in a radial direction relative to the central axis; and a spring compressed between the hub and the centrifugal weight to bias the centrifugal weight in a radial direction towards the central axis; wherein the centrifugal weight comprises a drive feature on a radially outer surface, and wherein the drive feature is configured to selectively interface with the drive surface of the sprocket when the output shaft is rotating above a threshold rotational speed.

In accordance with another embodiment, a clutch for an electric chainsaw is provided. The clutch includes a hub comprising: a major surface defining a central opening configured to receive an output shaft of a motor and key the hub to the output shaft; a rim extending around a perimeter of the major surface; a first tracking feature extending across the major surface; a first centrifugal weight movable in a radial direction relative to the central axis, the first centrifugal weight comprising: a body defining a second tracking feature configured to interface with the first tracking feature to guide movement of the first centrifugal weight relative to the hub in the radial direction; and a drive feature configured to interface with a driven surface of a sprocket of the electric chainsaw; a second centrifugal weight movable in a radial direction relative to the central axis, the second centrifugal weight comprising: a body defining the second tracking feature configured to interface with the first tracking feature to guide movement of the second centrifugal weight relative to the hub in the radial direction; and a drive feature configured to interface with a driven surface of a sprocket of the electric chainsaw; a first spring compressed between the rim of the hub and the first centrifugal weight to bias the first centrifugal weight in a radial direction towards the central axis; and a second spring compressed between the rim of the hub and the second centrifugal weight to bias the second centrifugal weight in a radial direction towards the central axis, wherein the first and second centrifugal weights are each configured to selectively move from a disengaged position to a drive position when hub is rotated about the central axis above a threshold rotational speed.

In accordance with another embodiment, a chainsaw is provided. The chainsaw includes A chainsaw comprising: a housing; a bar extending from the housing and defining a track; a chain movable relative to the track; an electric power source; a motor configured to receive power from the electric power source and drive an output shaft; a sprocket operably coupled to the chain and configured to drive the chain on the track, wherein the sprocket comprises a receiving area defining a drive surface on a radially inner surface of the receiving area; a clutch disposed at least partially in the receiving area of the sprocket, wherein the clutch comprises: a first centrifugal weight including a first drive feature on a radially outer surface, wherein the first drive feature is configured to selectively interface with the drive surface of the sprocket when the output shaft is rotating above a threshold rotational speed; and a second centrifugal weight including a second drive feature on a radially outer surface, wherein the second drive feature is configured to selectively interface with the drive surface of the sprocket when the output shaft is rotating above the threshold rotational speed, wherein the first and second centrifugal weights translate in a radial direction between an inner position and an outer position, wherein the first and second centrifugal weights are biased to the inner position by a spring, and wherein the first and second centrifugal weights are configured to translate towards the outer position when the output shaft is driven by the motor to speeds above the threshold rotational speed.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

The detailed description that follows makes reference to the appended figures, in which:

FIG. 1 is a perspective view of a chainsaw and an enlarged portion of a chainsaw in accordance with embodiments of the present disclosure as seen with a portion of a housing of the chainsaw removed;

FIG. 2 is a perspective view of a gearcase, clutch, and sprocket of the chainsaw in accordance with embodiments of the present disclosure;

FIG. 3 is an exploded view of a clutch and sprocket of the chainsaw in accordance with embodiments of the present disclosure;

FIG. 4 is a plan view of the clutch and sprocket in accordance with embodiments of the present disclosure as seen with the clutch in a deactivated state;

FIG. 5 is a plan view of the clutch and sprocket in accordance with embodiments of the present disclosure as seen with the clutch in an activated state;

FIG. 6 is a plan view of the clutch and sprocket in accordance with embodiments of the present disclosure as seen with the clutch in the activated state; and

FIG. 7 is a plan view of the clutch and sprocket in accordance with embodiments of the present disclosure as seen with the clutch in the deactivated state;

FIG. 8 is a cross-sectional view of the clutch and sprocket as seen along Line A-A in FIG. 5 in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

In general, chainsaws and clutches for chainsaws described herein allow for automatic activation and deactivation of an internal clutch. When the clutch is activated, the clutch allows power from a motor of the chainsaw to reach the chain and drive the chain about a chain bar. When the clutch is deactivated, the chain is disconnected from the motor and free to move about the bar. Activation of the clutch can occur automatically in response to the motor, and more particularly an output shaft of the motor (or gearcase) reaching a threshold rotational speed. At and above the threshold rotational speed, the motor can drive the chain to move about the bar. Below the threshold rotational speed, the motor does not drive the chain to move about the bar. The clutch can automatically switch to the activated state when the clutch is rotated at speeds at and above the threshold rotational speed. The clutch can automatically switch to the deactivated state when the clutch is rotated at speeds below the threshold rotational speed.

The clutch includes a plurality of weighted elements, e.g., centrifugal weights, that move in the radial direction. The weighted elements are guided to move in translation along a hub of the clutch. For example, the hub can include a tracking feature, such as a rail, which guides complementary tracking features, such as grooves, in the weighted elements. The weighted elements can move along the hub in a straight line without rotating relative to the hub. When the weighted elements reach a critical position, drive features of the weighted elements can interact with a drive surface of a sprocket to drive the sprocket in a rotational manner. The sprocket can interact with the chain, directly or indirectly, to drive the chain about the bar. The weighted elements reach the critical position when the clutch is rotated at or above the threshold rotational speed. When the clutch no longer rotates at or above the threshold rotational speed, the weighted elements can move inward away from the drive surface of the sprocket, causing the clutch to disengage from the sprocket and resulting in a disconnection between the motor and the chain. At such time, the chain is no longer driven by the motor.

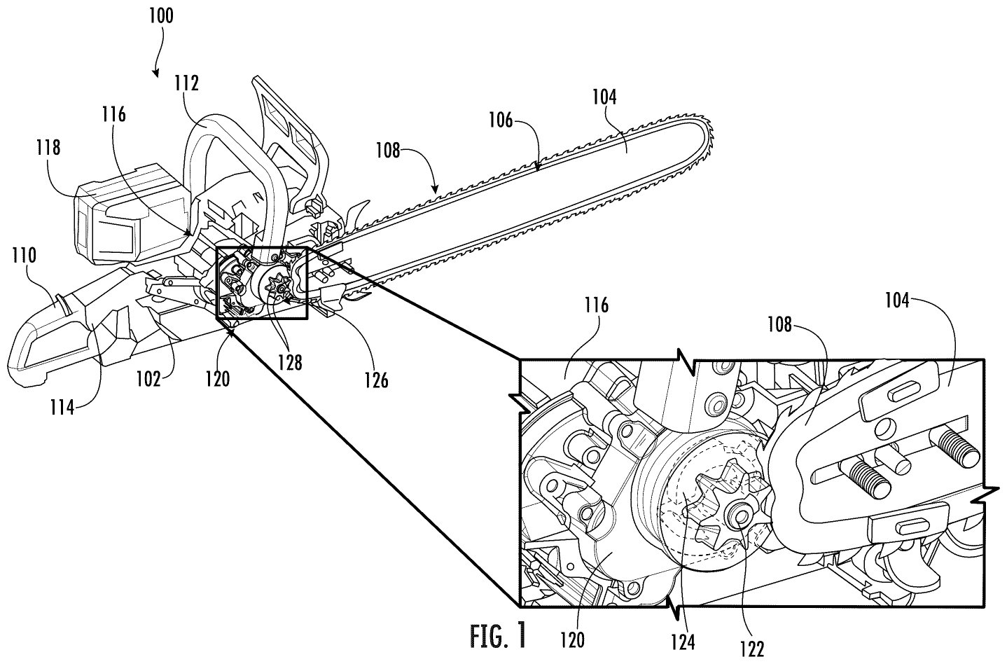

Referring now to the drawings, FIG. 1 illustrates a chainsaw 100 in accordance with an embodiment. The chainsaw 100 is an electric chainsaw including a housing 102, a bar 104 extending from the housing 102. The bar 104 defines a track 106 in which a chain 108 can move. The housing 102 can include a first handle 110 and a second handle 112. The first handle 110 can include a user actuatable element, such as a trigger 114 operatable by a user to selectively activate a motor 116. The motor 116 receives power from an electric power source, such as a battery 118. The battery 118 can be removably coupled to the housing 102, such as at a rear portion of the housing 102. The trigger 114 can be movable between a first position (associated with an OFF state) and a second position (associated with a maximum speed of the motor 116). The trigger 114 allows a user to adjust the speed of the motor 116 between the OFF state and the maximum speed. A gearbox 120 is coupled to the motor 116 and receives power from the motor 116. The gearbox 120 includes an output shaft 122 (which alternatively can be an output shaft of the motor 116) extending from the gearbox 120. The gearbox 120 can have a gear reduction (e.g., 1 to 2) to increase available torque at the output shaft 122.

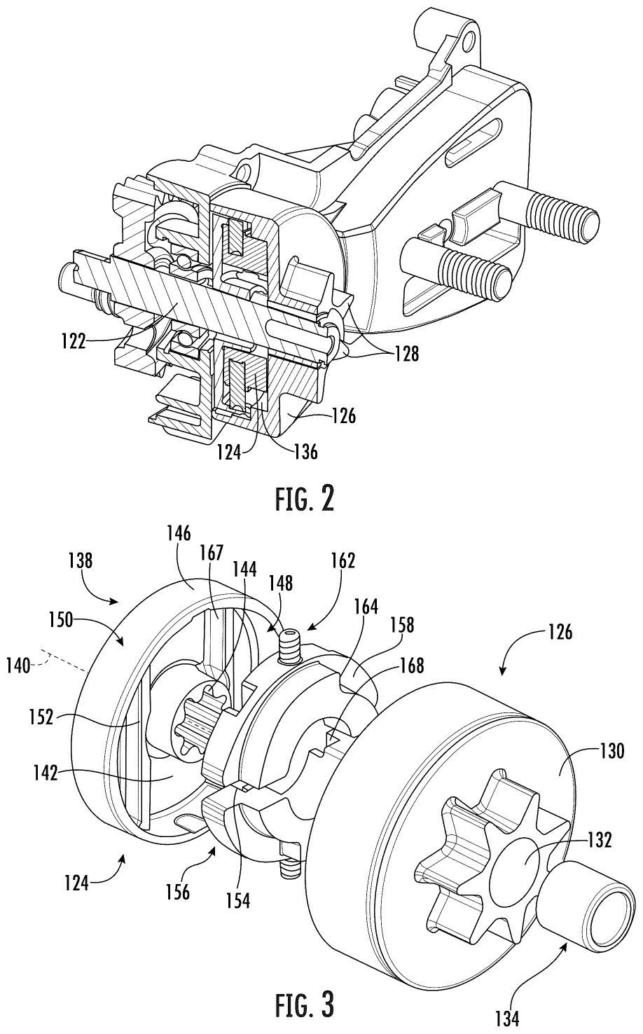

Referring to FIGS. 1 and 2, the output shaft 122 can be coupled to a clutch 124 that selectively interfaces with a sprocket 126 of the chainsaw 100. The sprocket 126 can include a plurality of teeth 128 that interface with the chain 108 to drive the chain 108 about the track 106 when the clutch 124 is in an engaged (drive) state and the motor 116 is activated. When the clutch 124 is in a disengaged (non-drive) state, the clutch 124 can allow the output shaft 122 of the motor 116 to rotate without transferring rotational motion to the sprocket 126.

FIG. 3 illustrates an exploded view of the clutch 124 and sprocket 126 in accordance with an exemplary embodiment. The sprocket 126 includes a body 130 defining an aperture 132 disposed at a central axis of the body 130. A bearing 134 is disposed within the aperture 132 and can support the sprocket 126 relative to the output shaft 122. The teeth 128 extend from the body 130 in a radial direction. The teeth 128 can interact directly or indirectly with the chain 108 (FIG. 1) to drive the chain 108 within the track 106 of the bar 104.

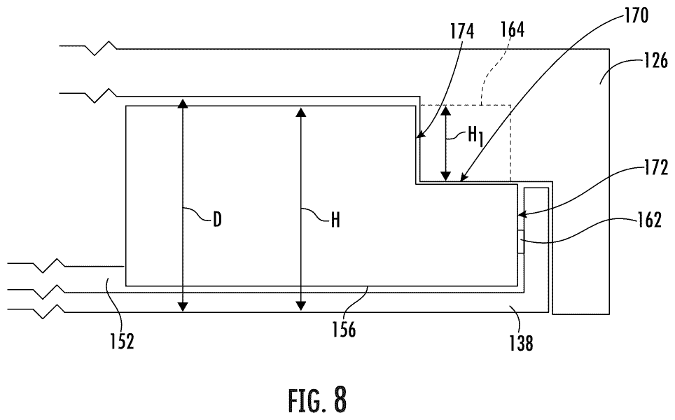

The clutch 124 fits at least partially within a receiving area 136 (FIG. 2) of the sprocket 126 and selectively transfers rotational motion from the output shaft 122 to the sprocket 126. The receiving area 136 can be disposed on an opposite side of the body 130 of the sprocket 126 as compared to the teeth 128. The receiving area 136 can be centered relative to the body 130 of the sprocket 126. The receiving area 136 can include a concave receiving area, such as a pocket, defined by the body 130. The receiving area 136 is sized to receive at least a portion of the clutch 124. For instance, the receiving area 136 can define a depth D (FIG. 8) and the clutch 124 can define a height H (FIG. 8). At least a portion of H can fit within D. In a particular embodiment, the receiving area 136 can receive the entire clutch 124. That is, the entire clutch 124 can fit within the receiving area 136.

The clutch 124 includes a hub 138 defining a central axis 140. The hub 138 can have a major surface 142 oriented perpendicular to the central axis 140. The major surface 142 can define a central opening 144 configured to receive the output shaft 122 and rotationally key the hub 138 to the output shaft 122. A rim 146 can extend around a perimeter of the major surface 142. The rim 146 can define an inner sidewall 148 and an outer sidewall 150 separated from the inner sidewall 148 by a thickness of the rim 146, as measured in the radial direction.

In an embodiment, the hub 138 includes a first tracking feature 152 that extends along the major surface 142 of the hub 138. The first tracking feature 152 can be unitary (i.e., formed from a single piece) with the major surface 142 of the hub 138. The first tracking feature 152 can extend between different portions of the rim 146. The first tracking feature 152 provides guiding support for one or more centrifugal weights that move relative to the major surface 142. In some instances, the first tracking feature 152 is configured to provide guiding support for a plurality of centrifugal weights. For example, as depicted in FIG. 3, the centrifugal weights can include a first centrifugal weight 156 and a second centrifugal weight 158. The first and second centrifugal weights 156 and 158 can be spaced apart circumferentially about the central axis 140 of the hub 138. The first tracking feature 152 can interface with (so as to guide) both the first and second centrifugal weights 156 and 158.

The first and second centrifugal weights 156 and 158 can move along the first tracking feature 152 between a radially inner position and a radially outer position. When the first and second centrifugal weights 156 and 158 are in the radially inner position, the clutch 124 is deactivated. When the first and second centrifugal weights 156 and 158 are in the radially outer position, the clutch 124 is activated.

In an embodiment, the first tracking feature 152 includes a ridge that projects away from the major surface 142. The first centrifugal weight 156 can define a second tracking feature 154, such as a groove, in which the ridge of the first tracking feature 152 is received. The groove of the first centrifugal weight 156 can move along the ridge to maintain a guided relationship between the first centrifugal weight 156 and the hub 138. The second centrifugal weight 158 can also define a second tracking feature, such as a groove, in which the ridge of the first tracking feature 152 is received. The groove of the second centrifugal weight 158 can move along the ridge to maintain a guided relationship between the second centrifugal weight 158 and the hub 138.

In some instances, the hub 138 can include a plurality of tracking features, such as the first tracking feature 152 and a third tracking feature 167. In an embodiment, the first and third tracking features 152 and 166 are oriented parallel with respect to one another. The first and second centrifugal weights 156 and 158 can each further include a fourth tracking feature 168 that is guided by the third tracking feature 167. In an embodiment, the third tracking feature 167 can include a similar construction as compared to the first tracking feature 152. For example, the third tracking feature 167 can include a ridge projecting away from the major surface 142. The fourth tracking feature 168 can include a groove which receives the ridge of the third tracking feature 167. In another embodiment, the third tracking feature 167 can be different than the first tracking feature 152. For example, the third tracking feature 167 can include a groove extending into the major surface 142. The fourth tracking feature(s) 168 can include ridges or projections that fit within the groove and guide the centrifugal weights 156 and 158 relative to the hub 138.

In an embodiment, at least one of the first and second centrifugal weights 156 and 158, such as both the first and second centrifugal weights 156 and 158, are biased towards the radially inner position (i.e., the deactivated state). For example, one or more springs 162 can bias at least one of the first and second centrifugal weights 156 and 158 in the radially inner direction. The spring(s) 162 can be selectable from a plurality of different springs each having a different spring constant. Selection of the appropriate spring 162 allows for tuning of the clutch 124. Relatively stiffer springs 162 increase the threshold rotational speed necessary to deploy the centrifugal weights 156 and 158 radially outwards to the activated state. Conversely, relatively weaker springs 162 decrease the threshold rotational speed necessary to deploy the centrifugal weights 156 and 158 radially outward to the activated state.

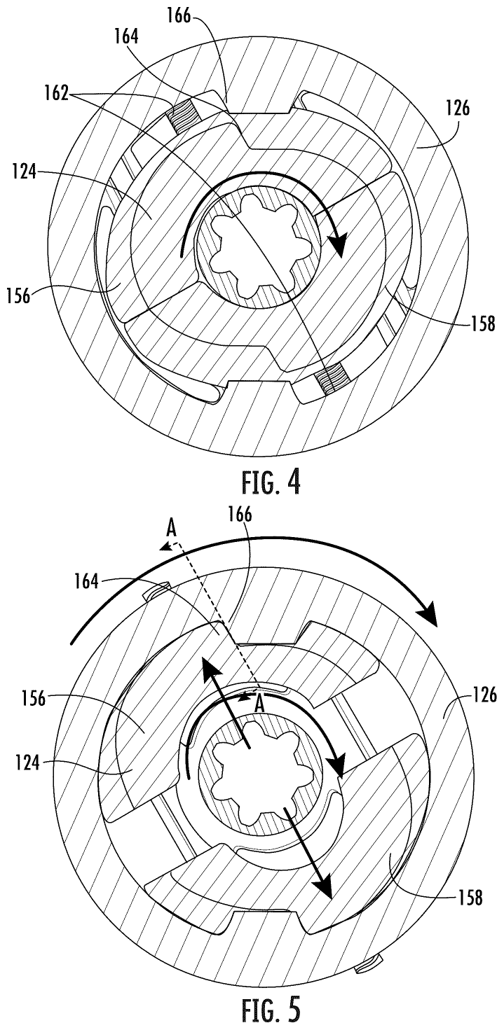

The first and second centrifugal weights 156 and 158 can each define radially outer surfaces including a drive feature 164. The drive feature 164 is configured to engage a drive surface 166 (FIG. 4) of the sprocket 126 to selectively drive the sprocket 126 when the centrifugal weights 156 and 158 are in the radially outer position (i.e., the activated state).

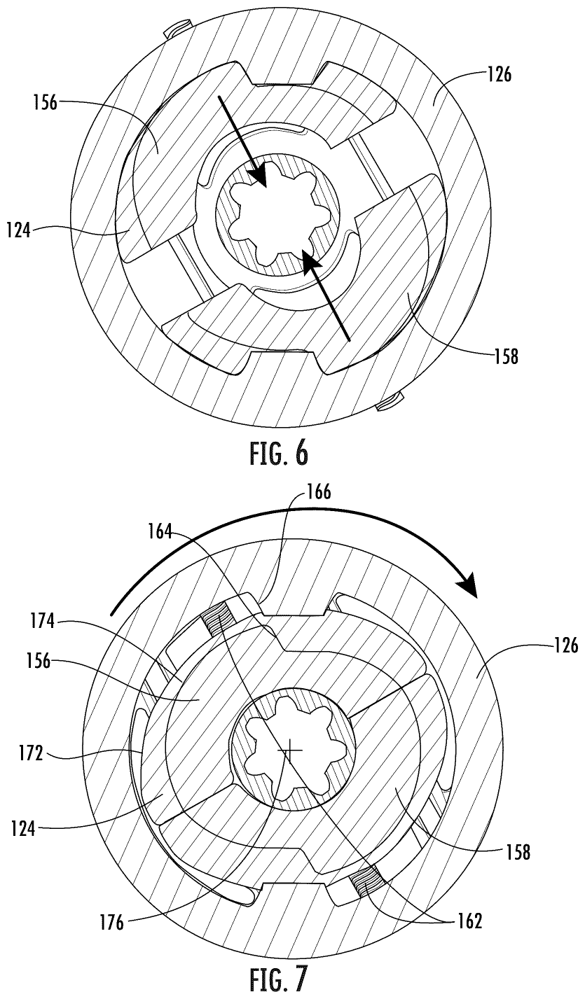

FIGS. 4 to 7 illustrate the clutch 124 in various states. In particular, FIGS. 4 and 7 illustrate the clutch 124 in the disengaged state where rotational motion imparted on the output shaft 122 is not transferred to the sprocket 126. FIGS. 5 and 6 illustrate the clutch 124 in the engaged state where rotational motion imparted on the output shaft 122 is transferred to the sprocket 126. The drive feature(s) 164 do not interact with the drive surface 166 of the sprocket 126 when the centrifugal weights 156 and 158 are in the radially inner position as depicted in FIG. 4. The centrifugal weights 156 and 158 are in the radially inner position, for example, when the motor 116 (FIG. 1) is not actively rotating the output shaft 122 or when the output shaft 122 is rotated at a speed less than a threshold rotational speed. At rotational speeds less than the threshold rotational speed, the force of the spring(s) 162 on the centrifugal weights 156 and 158 exceeds any outward force of the centrifugal weights 156 or 158. As the output shaft 122 is rotated at speeds at and above the threshold rotational speed, the centrifugal weights 156 and 158 displace in the radially outward direction as seen in FIG. 5. As the centrifugal weights 156 and 158 displace radially outward, the drive features 164 come into contact with the drive surface 166. Upon contact occurring between the drive features 164 and the drive surface 166, rotational movement of the output shaft 122 is transferred to rotational movement of the sprocket 126. The sprocket 126 can remain rotationally pinned to the output shaft 122 until such time that the rotational speed of the clutch 124 falls below the threshold rotational speed. As depicted in FIG. 6, dropping to speeds below the threshold rotational speed causes the centrifugal weights 156 and 158 to move radially inward, e.g., under radially inward force generated by the spring(s) 162. Once the centrifugal weights 156 and 158 are displaced in the radially inward direction by a sufficient distance as depicted in FIG. 7, the drive features 164 clear the drive surface 166 of the sprocket 126 and the sprocket 126 is uncoupled from the output shaft 122. In this state, rotational output at the output shaft 122 is not transferred to the sprocket 126 to drive the chain 108.

FIG. 8 is a cross-sectional view of a portion of the clutch 124 and sprocket 126 as seen along Line A-A in FIG. 5 in accordance with an embodiment. As depicted, the drive feature 164 of the first centrifugal weight 156 is engaged with the driving surface (see FIG. 5) of the sprocket 126. As illustrated, the first centrifugal weight 156 is in the radially outer position whereby the spring 162 is in a compressed state. The first centrifugal weight 156 includes a stepped outer surface 170 including, e.g., a first portion 172 and a second portion 174. The spring 162 is compressed between the first portion 172 and the rim 146 of the hub 138. The second portion 174 defines the drive feature 164 which interacts with the drive surface 166 of the sprocket 126 to rotationally key the centrifugal weight 156 to the sprocket 126 when the clutch 124 is in the activated state.

Referring again to FIG. 7, the first and second portions 172 and 174 of the first centrifugal weight 156 can define different outer surface 170 profiles as viewed in a direction parallel with a central axis 176 of the hub 138. For example, the first section 172 can have a generally arcuate profile, as viewed parallel with the central axis 176, and the second section 174 can have a variable profile. The variable profile of the second section 174 can allow for formation of the drive feature 164 at the second section 174. For instance, the drive feature 164 can have a height H1 (FIG. 8) that is less than the depth D of the receiving area 136.

In some implementations, the first and second centrifugal weights 156 and 158 can share a common physical arrangement. For example, the first and second centrifugal weights 156 and 158 can each have an outer surface 170 formed by a first portion 172 and a second portion 174 that together formed a stepped outer surface 170. The shapes of the first and second portions 172 and 174 of the first and second centrifugal weights 156 and 158 can have the same or similar shapes, sizes or both as compared to one another. In some instances, the first and second centrifugal weights 156 and 158 can share a common, or substantially common, mass as one another, a common, or substantially common, moment of inertia as one another, or both. In some instances, the springs 162 biasing each of the first and second centrifugal weights 156 and 158 can be the same as one another. In this regard, the first and second centrifugal weights 156 and 158 can move between the radially inner and radially outer positions at equal, or generally equal, rates as one another, removing clutch imbalance and resulting in the driving features 164 of each of the first and second centrifugal weights 156 and 158 contacting the complementary driving surfaces 166 of the sprocket 126 at the same, or substantially same, time as compared to one another.

An exemplary method of using the clutch 124 is described below. The clutch 124 defaults to the disengaged state when the chainsaw 100 is not in active use (i.e., the motor 116 is not activated). Thus, when the chainsaw 100 is at rest, the chain 108 is free to move within the track 106 of the bar 104. When the chainsaw 100 is used, the clutch 124 moves from the disengaged state to an engaged state. This process involves first providing rotational movement to the output shaft 122. This rotational movement causes the hub 138 of the clutch 124 to rotate as the hub 138 is rotationally keyed (pinned) to the output shaft 122. Centripetal acceleration of the first and second centrifugal weights 156 and 158 causes the centrifugal weights 156 and 158 to displace from radially inner positions (as seen with the chainsaw 100 in the inactive state) towards radially outer positions. As rotational speed of the output shaft 122 reaches a threshold speed, the centrifugal weights 156 and 158 reach a threshold radial position where contact between the drive features 164 of the centrifugal weights 156 and 158 and the drive surface 166 is achieved. At such time that contact between the drive feature(s) 164 and the drive surface 166 is achieved, the clutch 124 may be in the active state. In the active state, the clutch 124 transfers rotational energy from the output shaft 122 to the sprocket 126, driving the chain 108 about the bar 104. It is noted that the centrifugal weights 156 and 158 may continue displacing in the radially outward direction as the speed of the output shaft 122 continues to increase to the maximum speed of the motor 116. The drive features 164 can continue driving the drive surface 166 as the centrifugal weights 156 and 158 continue to move radially outward.

When the user releases or eases the trigger 114 past a certain point, or when the chain 108 becomes bogged down as a result of elevated resistance incurred by the chain 108 (e.g., as a result of binding in a material being cut), the rotational speed of the clutch 124 (and more particularly, the hub 138) drops below the threshold rotational speed and the centrifugal weights 156 and 158 return to the radially inner position. If the motor 116 is operated at the reduced speed (below the threshold rotational speed) for a sufficient duration of time, the drive features 164 of the centrifugal weights 156 and 158 disengage from the drive surface 166 of the sprocket 126. However, in some instances, the motor 116 may not remain at the reduced speed for a sufficient duration of time such that the drive features 164 disengage from the drive surface 166. In this regard, the speed of the hub 138 may temporarily drop below the threshold rotational speed without incurring disengagement of the clutch 124.

In the case where the chain 108 binds with the material being cut causing the motor 116 to slow beyond the threshold rotational speed, the drive features 164 disengage from the drive surface 166. With the drive features 164 disengaged from the drive surface 166, the motor 116 can again freely turn. If the user maintains the trigger 114 in the ON state (i.e., depressed), the motor 116 again rotates to speeds above the threshold rotational speed. As a result, the centrifugal weights 156 and 158 again move radially outward such that the drive features 164 interact with the drive surface 166. At such time, power is restored to the sprocket 126 and the chainsaw 100 attempts to overcome the bind on the chain 108. If successful, the chainsaw 100 then continues operating at the desired operating speed. If unsuccessful (i.e., the chain 108 is not freed), then the process repeats. That is, the drive features 164 again disengage from the drive surface 166 which allows the motor 116 to again increase speed past the threshold rotational speed, causing the drive features 164 to again interact with the drive surface 166 and attempt to unbind the chain 108. This process can repeat until the chain 108 is free of the bind or until such time that the user releases the trigger 114.

In an embodiment, the clutch 124 is configured to provide an indication to the user about a state of the chainsaw 100, such as when the motor 116 is overloaded. In some instances, the indication can include at least one of a tactile indication, an audible indication, or another type of indication. For example, with the clutch 124 slipped (i.e., moved to the disengaged state as a result of binding at the chain 108 while the trigger 114 is active), the motor 116 can quickly accelerate to rotational speeds above the threshold rotational speed. As a result, the drive feature 164 can come into contact with the drive surface 166 at a relatively fast speed while the drive surface 166 is stationary. This contact can result in a tactile feel which is transmitted to the user, e.g., through one or both of the handles 110 or 112. An audible indication can also occur as a result of contact between the drive feature 164 and the drive surface 166.

The chainsaw 100 is configured to operate at high speeds without losing efficiency at the clutch 124. That is, the chain 108 does not slip relative to the output shaft 122 as long as the clutch 124 is in the engaged state. In this regard, the clutch 124 maintains a constant efficiency at all speeds and powers of the motor when the drive feature 164 is interfaced with the drive surface 166 of the sprocket 126.

Further aspects of the invention are provided by one or more of the following embodiments:

Embodiment 1. An electric chainsaw comprising: a housing; a bar extending from the housing and defining a track; a chain movable relative to the track; an electric power source; a motor configured to receive power from the electric power source; a sprocket operably coupled to the chain and configured to drive the chain on the track, wherein the sprocket comprises a receiving area defining a drive surface on a radially inner surface of the receiving area; a clutch disposed at least partially in the receiving area of the sprocket, wherein the clutch comprises: a hub defining a central axis, the hub being rotationally keyed to an output shaft of the motor; a centrifugal weight disposed between the hub and the sprocket and movable in a radial direction relative to the central axis; and a spring compressed between the hub and the centrifugal weight to bias the centrifugal weight in a radial direction towards the central axis; wherein the centrifugal weight comprises a drive feature on a radially outer surface, and wherein the drive feature is configured to selectively interface with the drive surface of the sprocket when the output shaft is rotating above a threshold rotational speed.

Embodiment 2. The electric chainsaw of any one or more of the embodiments, wherein the centrifugal weight comprises a plurality of centrifugal weights disposed around the central axis, wherein the hub comprises a first tracking feature extending in a direction oriented parallel with the radial direction, wherein at least two of the plurality of centrifugal weights comprise a second tracking feature complementary to the first tracking feature, and wherein the centrifugal weights are guided by an interface formed between the first and second tracking features.

Embodiment 3. The electric chainsaw of any one or more of the embodiments, wherein the hub further comprises a third tracking feature extending parallel with the first racking feature, wherein the at least two of the plurality of centrifugal weights comprise a fourth tracking feature complementary to the third tracking feature, and wherein the centrifugal weights are guided by an interface formed between the third and fourth tracking features.

Embodiment 4. The electric chainsaw of any one or more of the embodiments, wherein the first and third tracking features each comprise a rail and the second and fourth tracking features each comprise a groove.

Embodiment 5. The electric chainsaw of any one or more of the embodiments, wherein the centrifugal weight is disengaged from the sprocket when the output shaft is rotating below the threshold rotational speed, and wherein the clutch is configured to rotate without driving the sprocket when the centrifugal weight is disengaged.

Embodiment 6. The electric chainsaw of any one or more of the embodiments, wherein the drive surface comprises a cylindrical surface including a projection extending radially inward towards the central axis, the projection comprising an engagement surface configured to selectively interface with the drive feature, and wherein the engagement surface is angularly offset from the radial direction.

Embodiment 7. The electric chainsaw of any one or more of the embodiments, wherein the receiving area defines a depth, wherein the projection defines a height, as measured in a direction parallel with the depth, and wherein the height is less than the depth.

Embodiment 8. The electric chainsaw of any one or more of the embodiments, wherein the centrifugal weight comprises a first portion and a second portion forming a stepped outer surface of the centrifugal weight, wherein the drive feature is disposed on the second portion, and wherein the spring is compressed between the hub and the first portion.

Embodiment 9. The electric chainsaw of any one or more of the embodiments, wherein the outer surface of the first portion has a first shape, as viewed in a direction parallel to the central axis, wherein the outer surface of the second portion has a second shape, as viewed in a direction parallel with the central axis, and wherein the first shape is different than the second shape.

Embodiment 10. The electric chainsaw of any one or more of the embodiments, wherein efficiency of the clutch remains constant at all speeds and powers of the motor when the drive feature is interfaced with the drive surface of the sprocket.

Embodiment 11. The electric chainsaw of any one or more of the embodiments, wherein the clutch is configured to provide an indication to a user that the motor is overloaded, and wherein the indication occurs while the motor is driving the clutch.

Embodiment 12. The electric chainsaw of any one or more of the embodiments, wherein the indication comprises a tactile indication transmitted to a handle of the electric chainsaw.

Embodiment 13. A clutch for an electric chainsaw, the clutch comprising: a hub comprising: a major surface defining a central opening configured to receive an output shaft of a motor and key the hub to the output shaft; a rim extending around a perimeter of the major surface; a first tracking feature extending across the major surface; a first centrifugal weight movable in a radial direction relative to the central axis, the first centrifugal weight comprising: a body defining a second tracking feature configured to interface with the first tracking feature to guide movement of the first centrifugal weight relative to the hub in the radial direction; and a drive feature configured to interface with a driven surface of a sprocket of the electric chainsaw; a second centrifugal weight movable in a radial direction relative to the central axis, the second centrifugal weight comprising: a body defining the second tracking feature configured to interface with the first tracking feature to guide movement of the second centrifugal weight relative to the hub in the radial direction; and a drive feature configured to interface with a driven surface of a sprocket of the electric chainsaw; a first spring compressed between the rim of the hub and the first centrifugal weight to bias the first centrifugal weight in a radial direction towards the central axis; and a second spring compressed between the rim of the hub and the second centrifugal weight to bias the second centrifugal weight in a radial direction towards the central axis, wherein the first and second centrifugal weights are each configured to selectively move from a disengaged position to a drive position when hub is rotated about the central axis above a threshold rotational speed.

Embodiment 14. The clutch of any one or more of the embodiments, wherein the hub further comprises a third tracking feature oriented parallel with the first tracking feature, wherein the first and second centrifugal weights each comprise a fourth tracking feature configured to guide movement of the first and second centrifugal weights relative to the hub in the radial direction.

Embodiment 15. The clutch of any one or more of the embodiments, wherein the body of the first centrifugal weight comprises a first portion and a second portion forming a stepped outer surface of the first centrifugal weight, wherein the drive feature is disposed on the second portion, and wherein the spring is compressed between the hub and the first portion.

Embodiment 16. The clutch of any one or more of the embodiments, wherein the first tracking feature extends continuously between a first end and a second end, and wherein the first and second ends of the first tracking feature are contiguous with the rim.

Embodiment 17. A chainsaw comprising: a housing; a bar extending from the housing and defining a track; a chain movable relative to the track; an electric power source; a motor configured to receive power from the electric power source and drive an output shaft; a sprocket operably coupled to the chain and configured to drive the chain on the track, wherein the sprocket comprises a receiving area defining a drive surface on a radially inner surface of the receiving area; a clutch disposed at least partially in the receiving area of the sprocket, wherein the clutch comprises: a first centrifugal weight including a first drive feature on a radially outer surface, wherein the first drive feature is configured to selectively interface with the drive surface of the sprocket when the output shaft is rotating above a threshold rotational speed; and a second centrifugal weight including a second drive feature on a radially outer surface, wherein the second drive feature is configured to selectively interface with the drive surface of the sprocket when the output shaft is rotating above the threshold rotational speed, wherein the first and second centrifugal weights translate in a radial direction between an inner position and an outer position, wherein the first and second centrifugal weights are biased to the inner position by a spring, and wherein the first and second centrifugal weights are configured to translate towards the outer position when the output shaft is driven by the motor to speeds above the threshold rotational speed.

Embodiment 18. The chainsaw of any one or more of the embodiments, wherein the clutch further comprises a hub including a first tracking feature extending in a direction oriented parallel with the radial direction, wherein the first and second centrifugal weights each comprise a second tracking feature complementary to the first tracking feature, and wherein the first and second centrifugal weights are guided by an interface formed between the first and second tracking features.

Embodiment 19. The chainsaw of any one or more of the embodiments, wherein the first centrifugal weight comprises a first portion and a second portion forming a stepped outer surface of the first centrifugal weight, wherein the drive feature is disposed on the second portion, and wherein the spring is compressed between the hub and the first portion.

Embodiment 20. The chainsaw of any one or more of the embodiments, wherein the clutch is configured to provide an indication to a user that the motor is overloaded, and wherein the indication occurs while the motor is driving the clutch.

The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An electric chainsaw comprising:
a housing;
a bar extending from the housing and defining a track;
a chain movable relative to the track;
an electric power source;
a motor configured to receive power from the electric power source;
a sprocket operably coupled to the chain and configured to drive the chain on the track, wherein the sprocket comprises a receiving area defining a drive surface on a radially inner surface of the receiving area;
a clutch disposed at least partially in the receiving area of the sprocket, wherein the clutch comprises:
a hub defining a central axis, the hub being rotationally keyed to an output shaft of the motor;
a centrifugal weight disposed between the hub and the sprocket and movable in a radial direction relative to the central axis; and
a spring compressed between the hub and the centrifugal weight to bias the centrifugal weight in a radial direction towards the central axis;
wherein the centrifugal weight comprises a drive feature on a radially outer surface, and wherein the drive feature is configured to selectively interface with the drive surface of the sprocket when the output shaft is rotating above a threshold rotational speed.

2. The electric chainsaw of claim 1, wherein the centrifugal weight comprises a plurality of centrifugal weights disposed around the central axis, wherein the hub comprises a first tracking feature extending in a direction oriented parallel with the radial direction, wherein at least two of the plurality of centrifugal weights comprise a second tracking feature complementary to the first tracking feature, and wherein the centrifugal weights are guided by an interface formed between the first and second tracking features.

3. The electric chainsaw of claim 2, wherein the hub further comprises a third tracking feature extending parallel with the first racking feature, wherein the at least two of the plurality of centrifugal weights comprise a fourth tracking feature complementary to the third tracking feature, and wherein the centrifugal weights are guided by an interface formed between the third and fourth tracking features.

4. The electric chainsaw of claim 3, wherein the first and third tracking features each comprise a rail and the second and fourth tracking features each comprise a groove.

5. The electric chainsaw of claim 1, wherein the centrifugal weight is disengaged from the sprocket when the output shaft is rotating below the threshold rotational speed, and wherein the clutch is configured to rotate without driving the sprocket when the centrifugal weight is disengaged.

6. The electric chainsaw of claim 1, wherein the drive surface comprises a cylindrical surface including a projection extending radially inward towards the central axis, the projection comprising an engagement surface configured to selectively interface with the drive feature, and wherein the engagement surface is angularly offset from the radial direction.

7. The electric chainsaw of claim 6, wherein the receiving area defines a depth, wherein the projection defines a height, as measured in a direction parallel with the depth, and wherein the height is less than the depth.

8. The electric chainsaw of claim 1, wherein the centrifugal weight comprises a first portion and a second portion forming a stepped outer surface of the centrifugal weight, wherein the drive feature is disposed on the second portion, and wherein the spring is compressed between the hub and the first portion.

9. The electric chainsaw of claim 8, wherein the outer surface of the first portion has a first shape, as viewed in a direction parallel to the central axis, wherein the outer surface of the second portion has a second shape, as viewed in a direction parallel with the central axis, and wherein the first shape is different than the second shape.

10. The electric chainsaw of claim 1, wherein efficiency of the clutch remains constant at all speeds and powers of the motor when the drive feature is interfaced with the drive surface of the sprocket.

11. The electric chainsaw of claim 1, wherein the clutch is configured to provide an indication to a user that the motor is overloaded, and wherein the indication occurs while the motor is driving the clutch.

12. The electric chainsaw of claim 11, wherein the indication comprises a tactile indication transmitted to a handle of the electric chainsaw.

13. A clutch for an electric chainsaw, the clutch comprising:
a hub comprising:
a major surface defining a central opening configured to receive an output shaft of a motor and key the hub to the output shaft;
a rim extending around a perimeter of the major surface;
a first tracking feature extending across the major surface;
a first centrifugal weight movable in a radial direction relative to the central opening, the first centrifugal weight comprising:
a body defining a second tracking feature configured to interface with the first tracking feature to guide movement of the first centrifugal weight relative to the hub in the radial direction; and
a drive feature configured to interface with a driven surface of a sprocket of the electric chainsaw;
a second centrifugal weight movable in a radial direction relative to the central axis, the second centrifugal weight comprising:
a body defining the second tracking feature configured to interface with the first tracking feature to guide movement of the second centrifugal weight relative to the hub in the radial direction; and
a drive feature configured to interface with a driven surface of a sprocket of the electric chainsaw;
a first spring compressed between the rim of the hub and the first centrifugal weight to bias the first centrifugal weight in a radial direction towards the central axis; and
a second spring compressed between the rim of the hub and the second centrifugal weight to bias the second centrifugal weight in a radial direction towards the central axis,
wherein the first and second centrifugal weights are each configured to selectively move from a disengaged position to a drive position when hub is rotated about the central axis above a threshold rotational speed.

14. The clutch of claim 13, wherein the hub further comprises a third tracking feature oriented parallel with the first tracking feature, wherein the first and second centrifugal weights each comprise a fourth tracking feature configured to guide movement of the first and second centrifugal weights relative to the hub in the radial direction.

15. The clutch of claim 13, wherein the body of the first centrifugal weight comprises a first portion and a second portion forming a stepped outer surface of the first centrifugal weight, wherein the drive feature is disposed on the second portion, and wherein the spring is compressed between the hub and the first portion.

16. The clutch of claim 13, wherein the first tracking feature extends continuously between a first end and a second end, and wherein the first and second ends of the first tracking feature are contiguous with the rim.

17. A chainsaw comprising:
a housing;
a bar extending from the housing and defining a track;
a chain movable relative to the track;
an electric power source;
a motor configured to receive power from the electric power source and drive an output shaft;
a sprocket operably coupled to the chain and configured to drive the chain on the track, wherein the sprocket comprises a receiving area defining a drive surface on a radially inner surface of the receiving area;
a clutch disposed at least partially in the receiving area of the sprocket, wherein the clutch comprises:
a first centrifugal weight including a first drive feature on a radially outer surface, wherein the first drive feature is configured to selectively interface with the drive surface of the sprocket when the output shaft is rotating above a threshold rotational speed; and
a second centrifugal weight including a second drive feature on a radially outer surface, wherein the second drive feature is configured to selectively interface with the drive surface of the sprocket when the output shaft is rotating above the threshold rotational speed,
wherein the first and second centrifugal weights translate in a radial direction between an inner position and an outer position, wherein the first and second centrifugal weights are biased to the inner position by a spring, and wherein the first and second centrifugal weights are configured to translate towards the outer position when the output shaft is driven by the motor to speeds above the threshold rotational speed.

18. The chainsaw of claim 17, wherein the clutch further comprises a hub including a first tracking feature extending in a direction oriented parallel with the radial direction, wherein the first and second centrifugal weights each comprise a second tracking feature complementary to the first tracking feature, and wherein the first and second centrifugal weights are guided by an interface formed between the first and second tracking features.

19. The chainsaw of claim 18, wherein the first centrifugal weight comprises a first portion and a second portion forming a stepped outer surface of the first centrifugal weight, wherein the drive feature is disposed on the second portion, and wherein the spring is compressed between the hub and the first portion.

20. The chainsaw of claim 17, wherein the clutch is configured to provide an indication to a user that the motor is overloaded, and wherein the indication occurs while the motor is driving the clutch.
